(19) United States
(12) Patent Application Publication
(10) Pub. No.: US 2009/0103548 A1
(43) Pub. Date: Apr. 23, 2009

(54) Method for transmitting data in a communications network and transmit device and receive device for a communications network

(75) Inventor: Dominik Weiss, Aerzen (DE)

Correspondence Address: DeMont & Breyer, LLC, 100 Commons Way, Ste. 250, Holmdel, NJ, 07733, US

(73) Assignee: PHOENIX CONTACT GMBH & CO. KG, Blomberg (DE)

(21) Appl. No.: 12/252,770

(22) Filed: Oct. 16, 2008

(30) Foreign Application Priority Data
Oct. 23, 2007 (DE) 10 2007 050 941.5

(51) Int. Cl. H04L 12/28; H04J 3/00

(52) U.S. Cl. 370/395.53; 370/464

(57) ABSTRACT

According to the invention, data are transmitted by means of a data frame in a communications network from at least one subscriber connected to a communications network to at least one other subscriber similarly connected to the communications network, wherein the data are prepared for transmission in such a way that information for identifying or distinguishing the respective format of the data within a data frame is written into a field directly at the beginning of a data frame or into a field introducing a data frame.

The invention relates to a method for transmitting data in a communications network according to the preamble of Claim 1, to a transmit device and to a receive device according to Claims 9 and 10, respectively, and also to a communications system according to Claim 11.

Such methods, devices, and systems are already known in numerous configurations and are used in communications networks that allow data to be exchanged in the form of data frames. A data frame is here assembled from a number of fields that each contains a number of bits or bytes.

For example, in a communications network according to the Ethernet standard, data are exchanged in the form of Ethernet frames.

In the meantime, communications networks based on the Ethernet standard have also been used in the field of automated industrial manufacturing and are designated, in general, as Industrial Ethernet. Examples here are EtherCAT or Profinet. Here, Profinet allows, within one Ethernet frame, in particular within the data field of one Ethernet frame, both TCP/IP or UDP/IP based data transmission, as is typical in IT environments, and also real-time transmission of process and/or diagnostics data in which IP addressing and flow-control mechanisms of TCP or UDP are eliminated.

When receiving or reading an Ethernet frame, the respective format of the data within the data field can be identified or distinguished with reference to the Ethertype that is transmitted in an Ethertype field directly before the data field. For example, the Ethertype for IP data reads “0x0800” (IP v4) while the Ethertype for real-time data in Profinet reads “0x8892.”

In order to be able to achieve the shortest reaction times and latency times, especially for ever progressing demands on responsiveness and transmission speed, the various types of frame contents must be distinguished as fast as possible.

However, in an Ethernet frame, for example, before the Ethertype field that allows this differentiation, first are transmitted several other fields that are used, among other things, for addressing. The structure of an Ethernet frame will be discussed in more detail in the description of a preferred embodiment according to the invention.

Tests have shown that the pause (Inter Frame Gap, IFG) between two Ethernet frames provided in the Ethernet standard during transmission cannot be used without any problems for the transmission of additional control information that is used for the fastest possible differentiation. In measurements of electromagnetic compatibility (EMC measurements), a significantly worse behavior relative to interference is often observed when the pause between two frames is shortened.

Therefore, the invention is based on the task of allowing various types of frame contents to be distinguished more quickly while avoiding shortening of the pause between two successive data frames and also while avoiding worse interference immunity.

The task is achieved by the subject matter with the features of the respective independent claims.

Advantageous and/or preferred embodiments and improvements are the subject matter of the dependent claims.

According to the invention, data frames with various kinds of contents transmitted in a communications network can be distinguished more quickly in such a way that information for identifying the respective frame contents that might already be contained in another field within the data frame is provided at a position that can be accessed immediately when receiving or reading the data frame.

For this purpose, the invention provides a method for transmitting data by means of at least one data frame in a communications network, from at least one subscriber connected to the communications network to at least one other subscriber similarly connected to the communications network. According to the invention, the data are prepared for transmission in such a way that control information used for identifying or distinguishing the respective format of the data within a data frame is inserted into a field directly at the beginning of a data frame or into a field introducing a data frame that contains a number of bits or bytes.

Furthermore, the invention provides a transmit device for transmitting data by means of at least one data frame in a communications network from at least one subscriber connected to the communications network to at least one other subscriber similarly connected to the communications network. This transmit device that is suitable especially for use in the method according to the invention is distinguished in that it is constructed to insert control information used for identifying or distinguishing the respective format of the data of a data frame into a field directly at the beginning of a data frame or into a field introducing a data frame that contains a number of bits or bytes.

In addition, according to the invention, for receiving data transmitted by means of at least one data frame in a communications network from at least one subscriber connected to the communications network, a receive device is provided that is suitable especially for use in the method according to the invention and is constructed for identifying or distinguishing the various formats of the data within a data frame with reference to control information that is used for identifying or distinguishing the respective data format and that is included in a field directly at the beginning of a data frame or in a field introducing a data frame, wherein this field contains a number of bits or bytes.

Finally, a communications system formed from at least one such transmit device and from at least one such receive device similarly reproduces the concept according to the invention.

The invention provides the advantage of being able to distinguish as quickly as possible data frames received in a communications network according to their contents, thus guaranteeing the shortest reaction and latency times.

Here, specific to the application, the additional control information according to the invention is inserted or read out beginning at the position of the first byte or another byte of a field directly at the beginning of a data frame or a field introducing a data frame.

In a preferred embodiment of the method according to the invention, the information used for identifying or distinguishing the respective format of the data within a data frame is already contained in a field of the data frame other than the field at the beginning of a data frame or the field introducing a data frame.

In another preferred embodiment of the method according to the invention, the communications network is constructed according to the Ethernet standard and the data frame accordingly has the form of an Ethernet frame.

In an especially preferred embodiment of the method according to the invention, the field directly at the beginning of a data frame or the field introducing a data frame has the position and form of a bit sequence that can be or is used, in principle, as a preamble. Here, at least one part of the contents of the preamble is replaced by control information used for identifying or distinguishing the respective format of the data within a data frame. While the preamble of an Ethernet frame was originally used for bit synchronization of the subscriber connected to a communications network, today modern network subscribers are no longer ordered to perform this synchronization, so that, in principle, the preamble is functionless, but continues to be maintained in each Ethernet frame for conformance reasons. Due to the use of at least one part of the preamble for the insertion according to the invention of control information used for identifying the contents of an Ethernet frame, the form of an Ethernet frame can otherwise remain unchanged, so that an Ethernet frame adapted according to the invention remains readable to all network subscribers.

Preferably, in the method according to the invention, for the insertion of additional control information, it is further provided to use code or control words of the transmission code that were previously unused during the serialization/deserialization (SerDes) in connection with a transmission code and that were redefined in advance accordingly.

In particular, in another embodiment of the method according to the invention, the use of the 8B/10B code as the transmission code is provided, wherein, in practice, e.g., the previously unused code words “K28.0,” “K28.2,” and “K28.3” are redefined in such a way that they correspond to the control information “IT standard data,” “I/O data,” and “diagnostics data,” respectively.

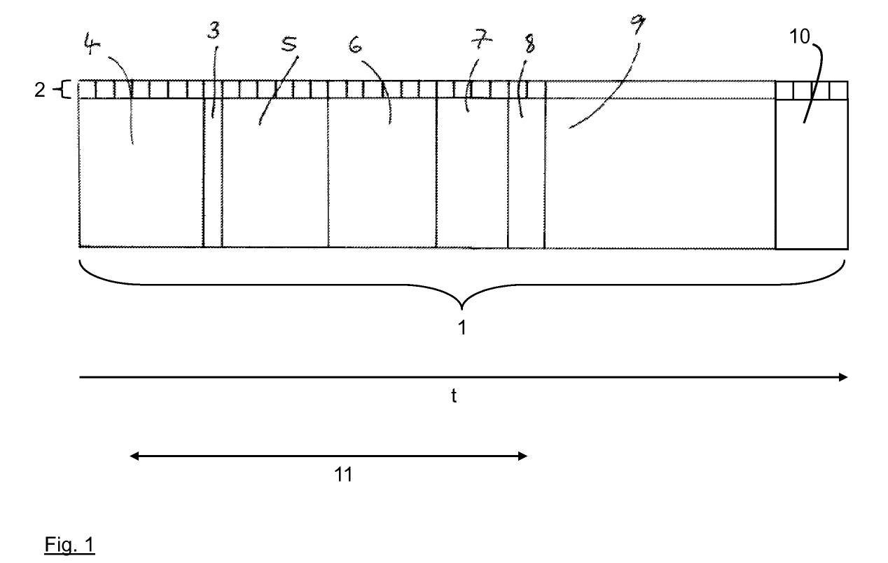

The invention will be explained in more detail below with reference to an embodiment in connection with the accompanying FIG. 1. Here it is understood that the illustrated representation is to be considered merely as a rough schematic sketch of the data structures used in the method according to the invention.

FIG. 1 shows the configuration of an Ethernet frame used for transmission according to the invention in communications networks. It is understood that a plurality of Ethernet frames following one after the other in time can also be included.

As is clear from FIG. 1, such an Ethernet frame 1 is composed of several different fields 3, . . . , that are transmitted one after the other in time according to the arrow t in the FIGURE and each contains a certain number 2 of bytes. Thus, the illustrated Ethernet frame 1 begins with a preamble 4, which a start frame delimiter 3 (SFD) follows. The preamble 4 is made from 7 bytes and the start frame delimiter 3 has the length of one byte. Then, within the Ethernet frame 1, with a length of 6 bytes is a target address field 5 that is followed by a source address field 6 with the same length.

Adjacent to the source address field 6 is an identification field 7 for a virtual local area network (VLAN) that has the length of four bytes. A so-called Ethertype field 8 made from two bytes is allocated after this identification field 7 in the time advancing sequence according to the arrow t in the FIGURE. The Ethertype field 8 contains information on the format of the data within the subsequent data field 9, wherein the data field 9 can contain up to 1500 bytes of data. Furthermore, a so-called PAD field (not shown) can be provided that is used, as a rule, for bringing an Ethernet frame 1 to a minimum size of 64 bytes required for transmission.

The end of the Ethernet frame 1 forms a check frame sequence 10 that represents a 32-bit CRC checksum (4 bytes) calculated across the frame beginning from the target address field 5 up to and including the PAD field. The preamble 4, the start frame delimiter 3, and the check frame sequence 10 itself are not taken into account in the check frame sequence 10.

In the conventional transmission method, the respective format of the data within the Ethernet frame 1 or the data field 9 can be identified or distinguished only after reading the Ethertype field 8.

According to the invention, the information used for identifying the respective format of the data within an Ethernet frame 1 is already available when the preamble 4 is read, so that a time advantage 11 is achieved. This time advantage corresponds to the time needed for reading the fields 3 to 8 following the preamble 4.

According to the invention, the additional control information is used to more quickly distinguish the respective format of the data within an Ethernet frame 1, in an especially preferred way inserted into the preamble 4 such that for this purpose a previously unused code or control word of the 8B/10B code is used that was previously redefined accordingly. In the serialization/deserialization in connection with the transmission code 8B/10B, a previously unused code or control word of the 8B/10B code is used that was redefined in advance accordingly, for example, “K28.0” for the control information “IT standard data,” “K28.2” for the control information “IT standard data,” and “K28.3” for the control information “diagnostics data.”

1. Method for transmitting data by means of a data frame (1) in a communications network from at least one subscriber connected to the communications network to at least one other subscriber similarly connected to the communications network, the method comprising:
preparing the data for transmission in such a way that information used for identifying or distinguishing the respective format of the data within a data frame (1) is inserted into a field (4) directly at the beginning of a data frame (1) or into a field (4) introducing a data frame (1).

2. Method according to claim 1 characterized in that
the information used for identifying or distinguishing the respective format of the data within a data frame (1) is already contained in a field (8) of the data frame (1) other than the field (4) at the beginning of a data frame (1) or introducing a data frame (1).

3. Method according to claim 1, characterized in that
the communications network is configured according to the Ethernet standard and has the form of an Ethernet frame (1) according to the data frame (1).

4. Method according to claim 1, characterized in that
the field (4) directly at the beginning of a data frame (1) or the field (4) introducing a data frame (1) has the position and form of a bit sequence that can be used or is used as the preamble (4).

5. Method according to claim 1, characterized in that
at least one part of the content of the field (4) directly at the beginning of a data frame (1) or the field (4) introducing a data frame (1) is replaced by information used for identifying or distinguishing the respective format of the data within a data frame (1).

6. Method according to claim 1, characterized in that
the information is inserted in such a way that for the serialization/deserialization, a previously unused code or control word of the correspondingly utilized transmission code is used that was redefined in advance accordingly.

7. Method according to claim 6, characterized in that
the 8B/10B code is used as a transmission code.

8. Method according to claim 7, characterized in that
at least one of the previously unused codes or control words “K28.0,” “K28.2,” and “K28.3” is redefined so that it corresponds to the information “IT standard data,” “I/O data,” and “diagnostics data,” respectively.

9. Transmit device for transmitting data by means of a data frame (1) in a communications network from at least one subscriber connected to the communications network to at least one other subscriber similarly connected to the communications network, configured for use in a method according to claim 1 and characterized in that
the transmit device is configured to insert information used for identifying or distinguishing the respective format of the data within a data frame (1) into a field directly at the beginning (4) of a data frame (1) or into a field (4) introducing a data frame (1).

10. Receive device for receiving data transmitted by means of a data frame (1) in a communications network from at least one subscriber connected to the communications network, configured for use in a method according to claim 1 and characterized in that
the receive device is configured to identify or to distinguish the various formats of data within a data frame (1) with reference to information that is used for identifying or distinguishing the respective data format and that is contained in a field (4) directly at the beginning of a data frame (1) or in a field (4) introducing a data frame (1).

11. Communications system comprising at least one transmit device according to claim 9 and at least one receive device according to claim 10.
